(19) United States
(12) Patent Application Publication
(10) Pub. No.: US 2019/0358547 A1
(43) Pub. Date: Nov. 28, 2019

(54) SPECTATOR VIRTUAL REALITY SYSTEM

(71) Applicant: LIGHTCRAFT TECHNOLOGY LLC, Culver City, CA (US)

(72) Inventors: Newton Eliot Mack, Culver City, CA (US); Philip R. Mass, Culver City, CA (US); Winston C. Tao, Culver City, CA (US)

(73) Assignee: LIGHTCRAFT TECHNOLOGY LLC, Culver City, CA (US)

(21) Appl. No.: 16/349,813

(22) PCT Filed: Apr. 17, 2017
(86) PCT No.: PCT/US17/27993

§ 371 Date: May 14, 2019

Related U.S. Application Data
(63) Continuation-in-part of application No. PCT/US17/27960, filed on Apr. 17, 2017.
(60) Provisional application No. 62/421,952, filed on Nov. 14, 2016.
(60) Provisional application No. 62/421,939, filed on Nov. 14, 2016.

(51) Int. Cl. A63F 13/86; G06T 19/00; A63F 13/53; G06K 9/00; G09G 5/02; G02B 27/01; G02B 27/00; G06T 15/00

(52) U.S. Cl. CPC A63F 13/86; G06T 19/006; A63F 13/53; G06T 15/005; G09G 5/026; G02B 27/0172; G02B 27/0093; G06K 9/00671

(57) ABSTRACT

A system which enables third person observation of an AR or VR player and their interaction with the virtual environment, including a separate live action spectator camera, a system to track that camera, and a system to integrate the live action and virtual images in real time.

### CROSS-REFERENCE TO RELATED APPLICATIONS

This application is a 35 U.S.C. § 371 National Stage Entry of International Application No. PCT/US2017/027993, filed Apr. 17, 2017, which claims the priority benefit of U.S. Provisional Patent Application No. 62/421,952, filed Nov. 14, 2016 and U.S. Provisional Patent Application No. 62/421,939, filed Nov. 14, 2016; and International Application No. PCT/US2017/027993, filed Apr. 17, 2017 is a continuation-in-part of International Application No. PCT/US2017/027960, filed Apr. 17, 2017, which claims the priority benefit of U.S. Provisional Patent Application No. 62/421,939, filed Nov. 14, 2016, all of which are incorporated herein by reference in their entirety for all purposes.

### BACKGROUND

This disclosure relates generally to the technology of combining the live action image of a person using a virtual reality or augmented reality device with the virtual background of the game or application that they are using into a finished composite image. More specifically, the disclosure relates to methods for precisely combining the virtual and live action elements so that the user's interaction with the virtual world can be easily observed and understood by external observers.

Virtual reality and mixed reality have existed in one form or another for many years, going back to the pioneering work of Ivan Sutherland in the 1960s. The typical form of the device is some sort of head mounted viewer and head motion tracking system, connected to a method of generating images that change as the user's head moves around the scene. The images are sent into the head-mounted viewer, and the user perceives a 3D world that either augments or replaces the user's actual surroundings.

More recently, the rendering speed of video game graphics, and the precision of low cost tracking systems resulted in a new wave of virtual reality (VR) and augmented reality (AR) devices, such as those made by Oculus Corporation of Irvine, Calif., or the HTC Corporation of Taipei City, Taiwan. The resulting explosion in use of these types of systems resulted in many thousands of people trying this new medium, but brought to the forefront a major problem inherent to the headset-based rendering, namely, a spectator has difficulty comprehending what the primary user is experiencing.

It is straightforward to simply mirror the view from the headset onto a PC monitor, but the rapid motion of most people's heads while playing is extremely disorienting to spectators who are not moving, and the doubled image required for viewing a correct stereo 3D image by the player is confusing and redundant to the spectator, who is generally observing the action on a standard 2D screen. There have been a variety of attempts to solve this problem, which generally revolve around a spectator camera viewing the player from a third person viewpoint, and some way of combining the virtual and live action worlds into a single image. The overall goal is to see the player integrated with the virtual environment.

Valve and HTC, the two companies that created the Vive VR system, created a pioneering video called “Virtual Reality—SteamVR featuring the HTC Vive,” available on Youtube. (https://www.youtube.com/watch?v=qYfNzhLXYGc) The method used in this video (and in most videos of this type) is to place a green screen behind and surrounding the player, and to mount a tracking sensor onto a separate video camera which is then used to capture the player's motion from a spectator point of view. The tracking sensor in the Vive video (and in most of the other videos produced in this way) is typically of the same type as is used to track the hand motion of the players, and uses the same overall tracking system as the rest of the system, including the head mounted display. This method helps to align the spectator camera to the player's movements, but has substantial limits in terms of camera motion.

### SUMMARY

Although the above-discussed sharing of tracking technologies has some benefits, including cost and automatic coordinate alignment with the rest of the system, it has a number of disadvantages when trying to shoot production videos of players, which are discussed below.

First, the major VR tracking systems require an unobstructed line of sight between the player's head mounted display (HMD) and hand controllers, and the stationary tracking base stations used. In the case of the Oculus, the tracking is achieved by a horizontally-facing video camera oriented toward markers on the headset. In the case of the Vive, the tracking is achieved by a pulsed infrared emitter, which sends out flashes of light that illuminate light sensors on the HMD and hand controllers. In both cases, the area between the base station and the user needs to be unobstructed for proper performance. The Oculus and the Vive both provide multiple base stations to attempt to solve this with overlapping coverage areas, but the basic problem still exists. That is, if the spectator/camera operator needs to be in the same tracking volume as the player, he will tend to occlude the player's tracking whenever he crosses over in front of a base station. This sudden loss of tracking can ruin a player's game and ruin the shot at the same time, which is problematic for high intensity e-sports and competitions.

Furthermore, the player cannot see the spectator/camera operator, and is typically moving their hand controllers very quickly through space to play the game. This is hazardous for the player, the camera operator, and the camera. Since the overall tracking volume is quite small (15′×15′ for the Vive), having multiple people in the same volume invites contact problems.

In addition, the previously-mentioned tracking volume constrains a preferred spectator location. For many games, with complex environments, the best point of view for the spectator is farther back, where they can see a wider area of the virtual environment, similar to where a spectator would sit for a sporting game, or even from above the player looking down. With the small volume available by the current generation of VR tracking hardware, the type of shot available is strictly limited. Since the base stations typically only track an eight-foot high envelope, positioning the camera overhead is impossible.

Furthermore, the various spectator VR devices used are restricted to a fixed focal length lens. Zoom lenses, however, are a stable of sports coverage, as the operator can instantly switch from a close-up shot to a wide angle shot to best capture the events of the game, so this ability would be very desirable for covering VR/AR e-sports.

All of the discussions have taken place with reference to VR and a green screen background, but the same limitations generally apply to using augmented reality without a green screen, where virtual characters are placed into the scene for the player to interact with. The same general tracking limitations apply.

Some attempts have been made to solve this, such as the work done by Fantastic Contraption. Their game merges spectator camera and game footage within the game itself, and renders the live action player as a panel directly within the game. (http://northwaygames.com/how-to-mixed-reality/) However, this method is limited to their game, and would require direct code modifications of any other game or application that attempted to use this technique. In addition, their method of aligning the spectator camera to the rest of the game is fairly imprecise, and requires substantial manual tweaking.

Other solutions involve creating a built-in level of mixed reality support at the original game engine level. This has been implemented by the Unity engine made by Unity Technologies of San Francisco, Calif. Any game with this feature enabled can enable mixed reality support automatically. However, there are a number of situations where this is not desirable. In many cases, the creator of the virtual background set or game is a different company than the group that is operating the mixed reality system. It would be ideal if the game creators could charge for the use of their asset in a video produced by the mixed reality production group, while keeping their IP secure and preventing it from being used without authorization.

An additional problem is that of conflicting frame rates. The spectator camera would ideally be set to use a standard video frame rate, such as 25.00 or 29.97 frames/second. If this exact frame rate is not delivered to the spectator camera, there will be very visible tearing or flickering between the live action foreground and the virtual background. For traditional virtual sets (such as those used in TV news, weather and sports) the solution is to run the entire rendering engine at exactly 25.0 or 29.97 frames per second. However, the requirements for the VR headset rendering are very different. The images in the VR headset must be updated to at least 90 frames/second, or the player will feel motion sickness.

Another problem is that any spectator camera used with a lens to capture a live action image of the player has the lens distortion inherent to a physical lens. Unless this lens distortion is properly accounted for, the player will not appear properly aligned with the virtual world, and the alignment error will increase with the use of wide angle lenses.

Additionally, since the player is experiencing an immersive VR world, with virtual elements both in front of and behind him, the spectator should be able to see the virtual environment rendered in the same way to avoid confusion, with virtual elements near to the spectator rendered in front of the player, and more distant elements rendered behind the player.

Another common requirement is simply tracking objects in the view of the spectator camera that will need to have CGI applied to them, such as a moving platform that the player is sitting on. This would occur with driving and flying simulations, as well as with background green ‘props’ with which the subject would need to interact. This problem also shows up with more traditional filmmaking VFX techniques.

Finally, since an increasing fraction of users' VR and AR experiences are happening on mobile devices, it is especially problematic to show what a mobile phone user is witnessing through their application.

Disclosed herein is a real time method for combining live action views of a VR or AR player with the surrounding virtual environment or characters. The spectator camera can be located outside or above the range of the VR/AR system's tracking volume. In addition, the spectator camera can be adapted so as to not interfere with the VR performance of the player. Furthermore, the spectator camera can be adapted to zoom and focus to best frame the player and virtual scene. The spectator camera can provide a view of augmented reality characters and games in cases where no green screen is used. In addition, the new method does not require direct code integration with the target application, and can be integrated with an existing game by using a simple pre-compiled plugin. Also, the game IP can be rented by a production company, with the original game assets protected from copying, and the rental handled by the separate compositing system.

Furthermore, it would be an improvement if it was straightforward to align the spectator VR camera with the player's VR experience, with the lens distortion of the physical spectator lens accounted for. In addition, the system can be configured to deliver precise video frame rates to the spectator camera without compromising the high frame rate rendering required by good VR/AR headsets. In addition, the user can be placed both in front of and behind the various virtual elements, without requiring rendering the user within the actual game code. Also, the other physical objects in the scene and the movement of the platform under the subject can be tracked. Finally, the spectator camera can see the experience as viewed by a mobile phone VR or AR user.

Various embodiments of a spectator VR viewing system are provided herein. In one embodiment, a spectator VR system includes a commercial VR or AR system such as the Oculus Rift or HTC Vive. The player can stand on a blue or green screen floor and in front of a blue or green screen background of a matching color. The system includes a separate wide area tracking system, which can be connected to a live action spectator camera, optionally with a lens that allows for adjustable zoom and focus. The wide area tracking system can include lens sensors or encoders to measure the current position of the lens zoom and focus adjustments. The wide area tracking system can be synchronized to the frame rate of the spectator camera, and sends time-synchronized data to the same computer that the VR/AR system is doing rendering on. This wide area tracker can be a Halide Tracker made by Lightcraft Technology of Santa Monica, Calif. And this computer can be a standard PC with powerful graphics hardware and a video I/O board.

The AR/VR imagery is typically generated by a real time 3D rendering engine, such as the Unity Engine made by Unity Technologies of San Francisco, Calif., or the Unreal Engine made by Epic Games of Cary, N.C. In a preferred embodiment, the engine can be the Unreal Engine. The time stamped spectator camera and lens tracking data can be sent to the 3D engine, which then recognizes the data and renders a matching frame. This data recognition can be performed by a plugin running inside the 3D engine. And this plugin can be the Halide Unreal plugin made by Lightcraft Technology of Santa Monica, Calif.

In order to composite the live action and virtual imagery together, a 2D compositing system needs to perform a keying operation on the incoming live action image and to combine the live action and 3D rendered image. This 2D compositing system can be the Halide FX system made by Lightcraft Technology of Santa Monica, Calif.

While the spectator camera tracking data is being rendered, at the same time the VR headset receives updated rendered frames from the 3D engine at a sufficiently high frame rate to avoid motion sickness on the part of the player. This VR frame rate can be at least ninety frames/second. The rate that the VR headset must be updated is very different from the precise video frame rate that the spectator camera needs to be updated. This can be achieved by making the 3D engine plugin operate in a non-blocking mode, so that it only queues a frame to be rendered by the real time 3D engine after it receives a packet of camera and lens tracking data from the wide area tracker, which are generated at the exact video frame rate needed.

The coordinate system of the wide area tracking system and the standard VR tracking system are aligned to ensure that the spectator camera's view is properly matched to the game. This can be achieved by marking the spots on the floor where the standard VR tracking origin is located and where the VR X-axis lies, overlaying a coordinate system origin marker onto the live action view of these two markers, and then adjusting the coordinate system offsets in the wide area tracking system until the wide area origin and the wide area X axis both line up with the marks on the floor.

The translation and rotation offsets between the wide area tracker and the spectator camera are established. This can be achieved by directing both tracker lens and spectator camera toward the same fiducial markers on the ceiling, calculating the pose of each, and using the delta between the two poses to determine the coordinate offset between the two systems. This can be accomplished by use of standard stereo camera matching calculations, such as those used in the open source OpenCV computer vision framework at opencv.org.

The portion of the virtual scene that should be located in front of the player (known as the foreground) can be known. The depth can be known by having the engine plugin read the XYZ coordinate position of the player's head mounted display from the 3D engine, and then sending that along with the rendered frame to the 2D compositing system. This can also be achieved by mounting a depth sensor to the spectator camera. The 3D position of the player's HMD can be passed to the 2D compositing system along with rendered scene depth information, and the combined depth and HMD information can be used to selectively composite virtual elements in front of or behind the live action image of the player.

Disclosed herein is a viewing system, which includes: a VR or AR system; a wide area tracking system that uses non-conflicting tracking technology matched with a coordinate system of the VR or AR system; a spectator camera configured to view a VR or AR player of the VR or AR system; and a compositing system configured to integrate the VR or AR player with a perspective matched view of a virtual environment that the player is experiencing from the point of view of the spectator camera. The compositing system can be configured to operate by receiving live video from the spectator camera and tracking information from the tracking system, reading lens optical data from a lens calibration, transmitting the tracking data to an external 3D engine, receiving rendered 3D frames from the 3D engine, and compositing the live video with the rendered 3D frames. The compositing system can also prevent tracking occlusion with the VR or AR system by allowing an operator of the spectator camera to be outside of a tracking range of the VR or AR system. The spectator camera can be operatively movable with respect to the VR or AR system so as to enable spectators to see the player's actions in the context of the game the player is playing.

Also disclosed herein is a method which includes transferring rendered color and depth information from an in-game plugin to an external compositing system to achieve integration of live action images of a player from a broadcast or cinema type of video camera with rendered virtual images from a separate 3D engine. The compiled plugin can be configured to receive tracking data and queue a frame to be rendered by the 3D engine, then send it back to the compositing system. The transferring can be by a shared memory connection, wherein upon execution each side of the transfer checks for an existing shared memory area, and creates a shared memory area if it does not exist. The virtual asset can be a VR or AR game and the plugin can be loaded into an existing game.

Further disclosed herein is a method which includes compiling a virtual asset with a pre-compiled spectator VR plugin added thereto to form a compiled asset. The plugin can be configured to receive tracking data, send rendered frames, query a payment system and stop execution of the compiled asset when specified. The method can also include the plugin, upon execution, checking to see if a compositing system is running on the same system that the compiled asset is on, and exiting if it is not present.

Even further disclosed herein is a method which includes: checking with a compiled plugin to see if payment for use of a virtual asset has been received and approved by a compositing system; if the checking reveals that payment has been received, receiving by the plugin at least one tracking data packet from the compositing system; after the receiving, sending from the plugin to the compositing system a virtual frame; and after the compositing system receiving the virtual frame, the compositing system combining the virtual frame with a live action frame to create a finished image. The data tracking packet can be used to set the virtual camera position in the 3D rendering plugin to decide which view of the virtual asset is to be rendered. The compiled plugin can be a compiled spectator VR plugin compiled into a game. The method can further include the compositing system counting frames of the rendered virtual asset used by the production company and sending virtual asset usage data to a payment system to charge for use of the virtual asset.

Still further disclosed herein is a system which includes: a spectator VR system; a mobile or smart phone; a compositing system having a high speed network connection with the phone; and a spectator camera configured to show a user of an AR or VR game on the phone immersed in the game. The game engine plugin in the phone can be configured to receive tracking data requests from a spectator VR system and to send back rendered frames.

Even still further disclosed herein is a system which includes: a spectator VR system; a separate VR system including a hand controller; a manually-operated support; the hand controller being on the support and movable around a scene by a person holding and manipulating the support; and real time tracking of a motion base or of props in the scene by linking motion of the hand controller to virtual objects in the scene, which are then observable by the spectator VR system. The manually-operated support can be a simple vehicle motion simulation.

Disclosed herein is a plugin having a tracking data receiving module, a virtual scene camera, and a frame transfer mechanism that can transfer rendered frames to external programs. The tracking data receiving module receives and interprets data packets containing camera position and lens optical data, the virtual scene camera uses this data to render a frame of the virtual scene contained in a 3D engine, and the transfer mechanism sends the rendered frame to a separate program from the 3D engine.

Also disclosed herein is a system which includes means for placing AR characters in a live action scene without using a blue or green screen. The means can include a compositing system configured for transferring tracking data to an external 3D rendering engine, receiving rendered frames with transparency data from the 3D rendering engine, and compositing the rendered frame into a live action frame by using the transparency data to control which part of the two images is contained in the final image.

Further disclosed herein is a system which includes: a 3D rendering engine; a spectator VR plugin; and means for simultaneously rendering in the 3D rendering engine and without conflicting (a) high frame rate AR and VR rendering and (b) low frame rate synchronized spectator camera rendering. The rendering means can include a non-blocking plugin that requests frame renders only upon receiving incoming tracking data. The high frame rate can be over sixty frames/second and the low frame rate can be a SMPTE video frame rate.

Still further disclosed herein is a method which includes: determining whether a compiled game containing a pre-compiled spectator VR plugin and in an executable form is authorized; if authorized, sending tracking data to the plugin; after the sending, receiving frames from the plugin; and compositing and color correcting the frame from the plugin with a live action frame. The sending tracking data can be only after receipt by the plugin of confirmation that payment from the virtual asset end user has been received and approved. The method can further include sending completed images of a virtual asset to a compositing system to be incorporated into a finished show.

Even still further disclosed herein is a method of renting a virtual asset which includes: adding in a pre-compiled plugin to the virtual scene in a game engine, that may not execute in the absence of a compositing system; compiling the game to generate a finished executable game; loading the game executable onto a computer with the compositing system that can connect to the pre-compiled game plugin; and charging a payment through the compositing system for final rendered frames generated by the compiled game asset.

Further to the paragraph above, the pre-compiled game plugin and the compositing system are both pieces of software created by the compositing software company. The game asset is created by a game generation company, and the final rendered frames are then created and owned by a production company. This separation of intellectual property enables the creation of a market where asset creators can rent their virtual assets to production companies, who will then make a finished product using the game asset but will not be able to copy or distribute the asset, or use it without paying. The payment mechanism is enforced by the company building the compositing system and the pre-compiled plugin. This method advantageously protects 3D assets from being copied while still enabling them to be loaded and used by a third party.

Disclosed herein is a method of renting a virtual asset which includes: adding in a pre-compiled plugin to a virtual scene in a game engine, that will not execute in the absence of a compositing system; compiling the game to generate a finished executable game; loading the game executable onto a computer with a compositing system that can connect to the pre-compiled game plugin; and charging a payment through the compositing system for final rendered frames generated by the compiled game asset.

### BRIEF DESCRIPTION OF THE DRAWINGS

The foregoing and other features and advantages of the present invention will be more fully understood from the following detailed description of illustrative embodiments, taken in conjunction with the accompanying drawings.

FIG. 1 is a perspective view of an embodiment in accordance with the present disclosure.

FIG. 2 is a schematic view of an embodiment in accordance with the present disclosure.

FIG. 3 is a top view of a player using a VR system along with a spectator camera operator in accordance with an embodiment of the present disclosure.

FIG. 4 is a top view of a player using a VR system along with a spectator camera operator in accordance with an embodiment of the present disclosure.

FIG. 5 is a perspective view of an embodiment in accordance with the present disclosure.

FIG. 6 depicts a live action and virtual image before and after being combined in accordance with the present disclosure.

FIG. 7 is a block diagram that depicts the data flow through the 2D compositing and 3D rendering system of the present disclosure.

FIG. 8 is a screen capture of the 3D coordinate system of a VR system in accordance with the present disclosure.

FIG. 9 is a perspective view of the 3D coordinate system of a VR system in accordance with the present disclosure.

FIG. 10 is a perspective view that depicts the steps to align coordinate systems in accordance with the present disclosure.

FIG. 11 is a block diagram that depicts the steps for user operation of a spectator VR system of the present disclosure.

FIG. 12 is a perspective view of an embodiment in accordance with the present disclosure.

FIG. 13 is a block diagram of an embodiment in accordance with the present disclosure.

FIG. 14 is a block diagram of an embodiment in accordance with the present disclosure.

### DETAILED DESCRIPTION

The following is a detailed description of the presently known best mode(s) of carrying out the inventions. This description is not to be taken in a limiting sense, but is made merely for the purpose of illustrating the general principles of the inventions.

A rapid, efficient, reliable system is disclosed herein for combining live action images of a VR user with matching virtual images in real time. Applications ranging from video games to industrial users can implement the system quickly and reliably. The system thereby can greatly reduce the cost and complexity of creating composite imagery, and enables a much wider usage of VR/AR use cases that require a spectator point of view of the VR/AR user's actions.

The process can work with a real-time video feed from a camera, which is presently available on most digital “still” cameras as well. The process can work with a “video tap” mounted on a film camera, in systems where the image is converted to a standard video format that can be processed. The process can also work with a cell phone type device.

The present disclosure can provide a method and apparatus for rapidly and easily combining live action and virtual elements, to enable rapidly changing the spectator camera position to best follow the action of a player using a VR system.

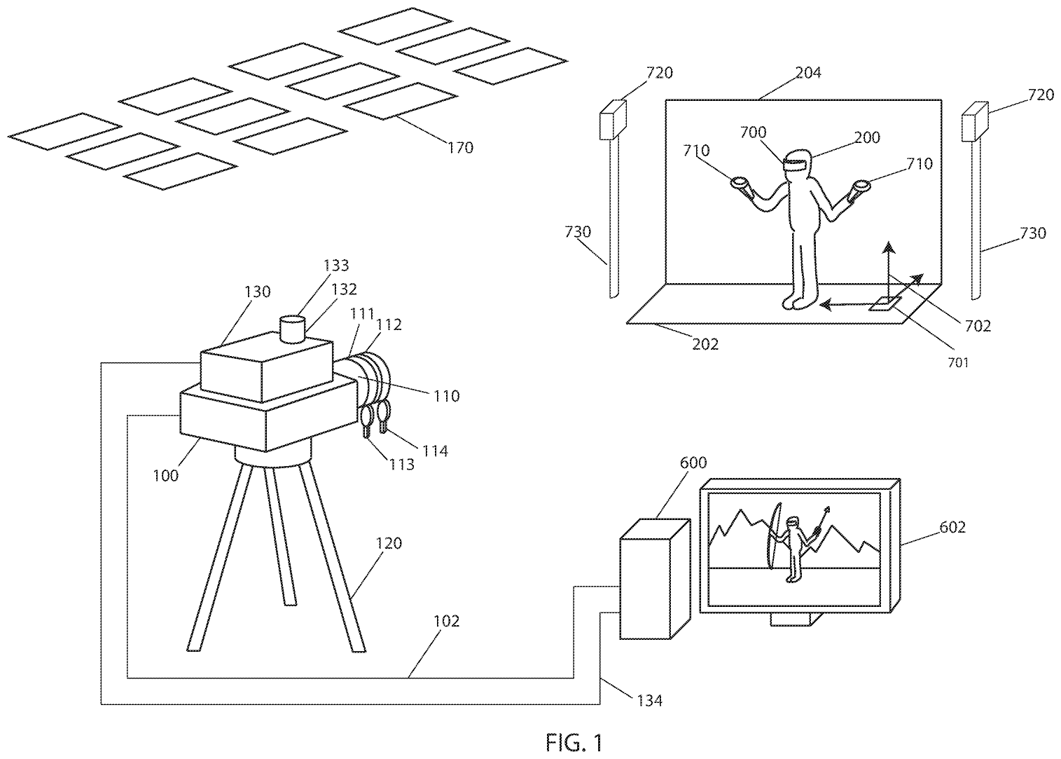

Referring to FIG. 1, an embodiment of the present disclosure is depicted. A scene camera 100 with lens 110 is positioned to capture a live action image 220 of a player 200 standing on a ground plane 202 in front of a background 204. The player(s) 200, for example, can be actors, props, and physical sets. The background 204 may be painted a blue or green color to enable separation of player 200 from the background 204; this paint can be Digital Green or Digital Blue paint from Composite Components Corporation of Los Angeles, Calif.

The scene camera 100 can be mounted on a camera support 120, which can be a tripod, dolly, Steadicam, or handheld type support. A wide area tracking sensor 130 is rigidly mounted to scene camera 100. The wide area tracking sensor 130 contains a tracking camera 132 with a wide angle lens 133. The wide area tracking sensor 130 can be the Halide Tracker made by Lightcraft Technology of Santa Monica, Calif.

The tracking camera 132 is used to recognize optical markers 170. Optical markers can consist of artificially-generated fiducial targets designed to be detected by machine vision, or naturally occurring features. The optical markers 170 can be artificially-generated fiducial targets. These markers 170 can be located on the ceiling, on the floor or anywhere in the scene that does not obstruct the scene camera's view of player 200. These markers 170 can be located on the ceiling pursuant to a preferred embodiment.

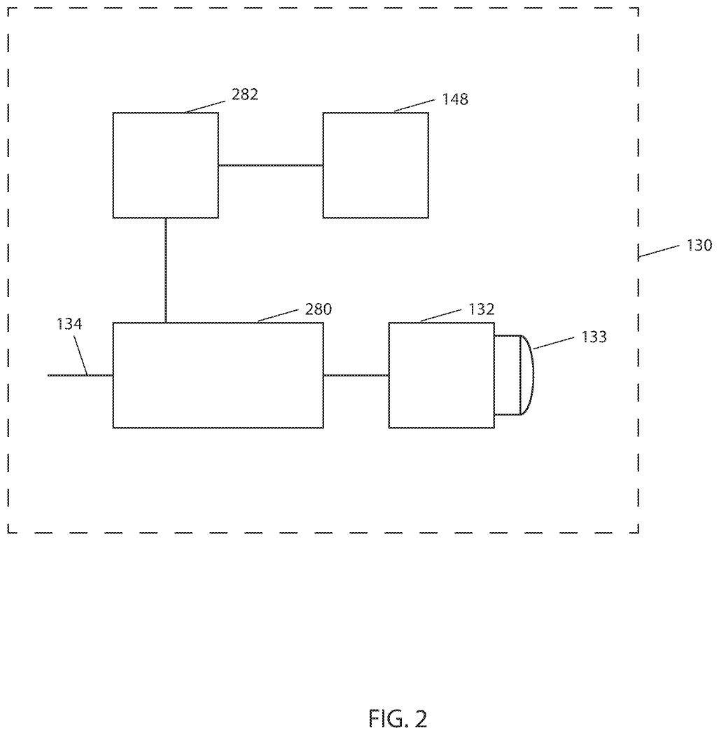

In a preferred embodiment, optical markers 170 can be artificial fiducial markers similar to those described in the AprilTag fiducial system developed by the University of Michigan, which system is well known to practitioners in the field. To calculate the current position of the tracking sensor in the world, a map of the existing fiducial marker positions is known. In order to generate a map of the position of the optical markers 170, a nonlinear least squared optimization is performed using a series of views of identified targets, in this case called a “bundled solve,” a method that is well known by machine vision practitioners. The bundled solve calculation can be calculated using the open source CERES optimization library by Google Inc. of Mountain View, Calif. (http://ceres-solver.org/nnls_tutorial.html#bundle-adjustment) Since the total number of targets is small, the resulting calculation is small, and can be performed rapidly with a single board computer 280 (FIG. 2) contained in the wide area tracking sensor 130.

Once the overall target map is known and tracking camera 132 can see and recognize at least four optical markers 170, the current position and orientation (or pose) of tracking sensor 130 can be solved. This can be solved with the Perspective 3 Point Problem method described by Laurent Kneip of ETH Zurich in “A Novel Parametrization of the Perspective-Three-Point Problem for a Direct Computation of Absolute Camera Position and Orientation.” The resulting target map is then matched to the physical stage coordinate system floor. This can be done by placing tracker 130 on the floor 202 while keeping the targets 170 in sight of tracking camera 132. Since the pose of tracking camera 132 is known and the position of tracking camera 132 with respect to the floor 202 is known (as the tracking sensor 130 is resting on the floor 202), the relationship of the targets 170 with respect to the ground plane 202 can be rapidly solved with a single 6DOF transformation, a technique well known to practitioners in the field.

Tracking sensor 130 has a serial connection 134 that sends serial tracking data 392 to a separate computer 600 with attached color calibrated monitor 602. In addition, scene camera 100 has a live video connection 102 that sends live video with timecode 220 out to computer 600. Live video connection 102 can be of a variety of standards capable of live video transfer; in a preferred embodiment this is the HD-SDI digital video standard.

Tracking sensor 130 contains an IMU 148 (FIG. 2) that is used to smooth out the pose of the sensor calculated from recognizing optical markers 170, which can otherwise generate noisy data. IMU 148 is connected to both a microcontroller 282 (FIG. 2) and the single board computer 280. Microcontroller 282 continuously integrates the optical camera pose from SBC 280 with the high speed inertial data from IMU 148 using a PID (Proportional, Integral, Derivative) method to resolve the error between the IMU pose and the optical marker pose. The PID error correction method is well known to a practitioner in real time measurement and tracking.

Lens 110 has a zoom ring 111 and a focus ring 112 that can rotate to adjust the zoom and focus of lens 110. The motion of zoom ring 111 and focus ring 112 are tracked by zoom sensor 113 and focus sensor 114. These sensors can be magnetic encoders made by U.S. Digital of Vancouver, Wash. The zoom and focus sensors 113 and 114 are connected to tracking sensor 130.

Player 200 is wearing a head mounted display (HMD) 700 that displays a virtual environment to player 200. Player 200 is holding hand controllers 710 that enable player 200 to interact with the virtual environment. The position and orientation of HMD 700 and hand controllers 710 are tracked by base stations 720. HMD 700, hand controllers 710 and base stations 720 can comprise the HTC Vive made by the HTC Corporation of Taipei, Taiwan. Base stations 720 are mounted slightly above head height on stands 730. They can either be mounted to the ceiling or the floor. In a preferred embodiment, they can be mounted to theatrical stands.

The tracking of HMD 700 and hand controller 720 is referenced to a virtual coordinate system 702, with the origin on the floor midway between the two base stations 720. Origin marker 701 is placed on the floor at the origin of coordinate system 702.

A schematic of an embodiment of the present disclosure is shown in FIG. 2. Tracking sensor 130 contains an IMU 148 that is used to smooth out the sensor position and orientation, or pose, calculated previously from recognizing optical markers 170, which can otherwise generate noisy data that is not suitable for tracking the motion of scene camera 100. IMU 148 is connected to a microcontroller 282, which is also connected to embedded computer 280. Embedded computer 280 is also connected to camera 132 with wide angle lens 133. Microcontroller 282 continuously combines the optical camera pose from embedded computer 280 with the high speed inertial data from IMU 148 using a PID (Proportional, Integral, Derivative) method to resolve the error between the IMU pose and the optical marker pose. The PID error correction method is well known to a practitioner in real time measurement and tracking. In a preferred embodiment, the IMU 148 can be a six degree of freedom IMU from Analog Devices of Norwood, Mass. In a preferred embodiment, the embedded computer 280 can be an Apalis TK1 single board computer from Toradex AG of Lucerne, Switzerland. In a preferred embodiment, the microcontroller 282 can be a 32-bit microcontroller from Atmel Corporation of San Jose, Calif.

The field of view of the lens 133 on tracking camera 132 is a trade-off between what the lens 133 can see, and the limited resolution that can be processed in real time. In a preferred embodiment, this wide angle lens 133 can have a field of view of about ninety degrees, which provides a useful trade-off between the required size of optical markers 170 and the stability of the optical tracking solution.

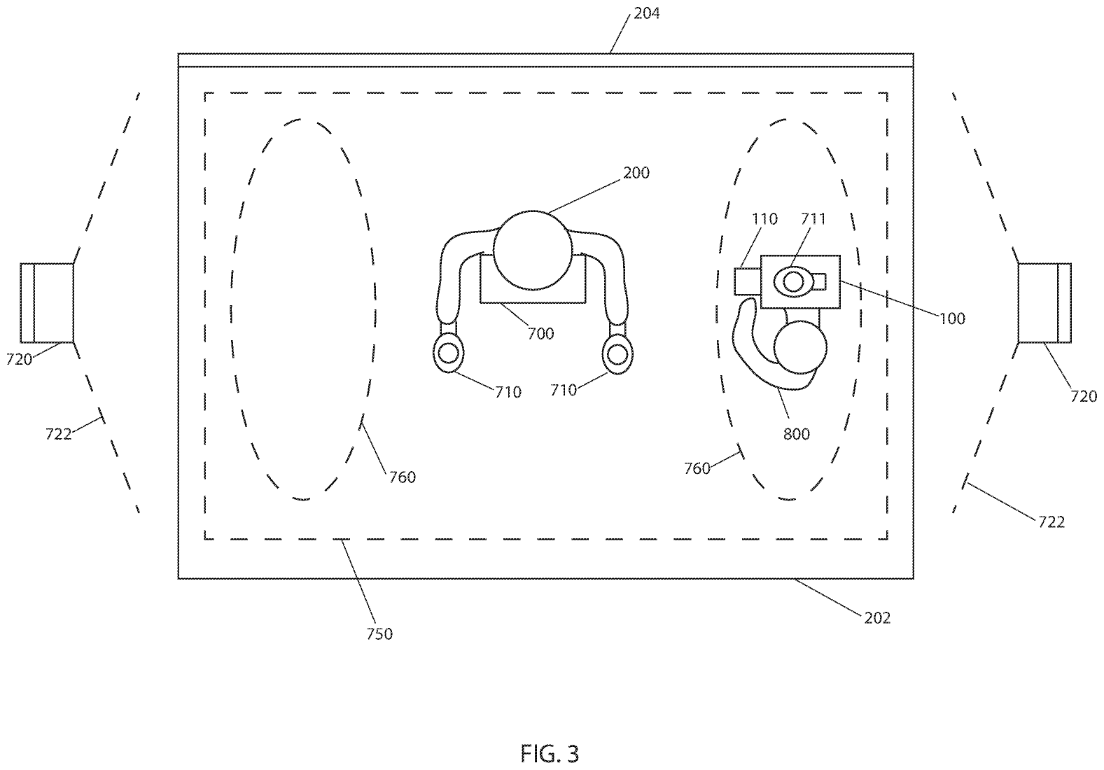

An embodiment of the present disclosure is illustrated in FIG. 3 where a player 200 wearing a HMD 700 is viewed from above. Player 200 is standing on a blue or green ground plane 202 and in front of a blue or green background 204. Player 200 is restricted to a player tracking area 750. Player tracking area 750 is determined by the positioning and maximum range of base stations 720, but has a typical maximum size of 15 feet×15 feet. Base stations 720 are located to either side of player tracking area 750. Base stations 720 each have a field of view 722 that determines the shape and range of player tracking area 750. This field of view can be one hundred and fifty degrees. In addition there is a spectator camera 100 with lens 110 and a tracking sensor 711. This tracking sensor 711 is the same type as is used for the hand controllers 710, but is fixed rigidly to the spectator camera 100. And spectator camera 100 is carried by camera operator 800.

Since camera operator 800 is located between base station 720 and player 200, and HMD 700 and hand controller 710 are all line-of-sight tracking devices, the presence of camera operator 800 in tracking volume 750 creates an occlusion zone 760. While camera operator 800 is standing in occlusion zone 750, the tracking of both HMD 700, hand controllers 710, and tracking sensor 711 are all compromised. This can take the form of lost tracking, or inaccurate tracking where the VR world no longer lines up well with the live action world in the view of player 200. This problem is inherent to line-of-sight tracking sensors, which are the type of sensor used in most major VR systems such as the Oculus and the Vive.

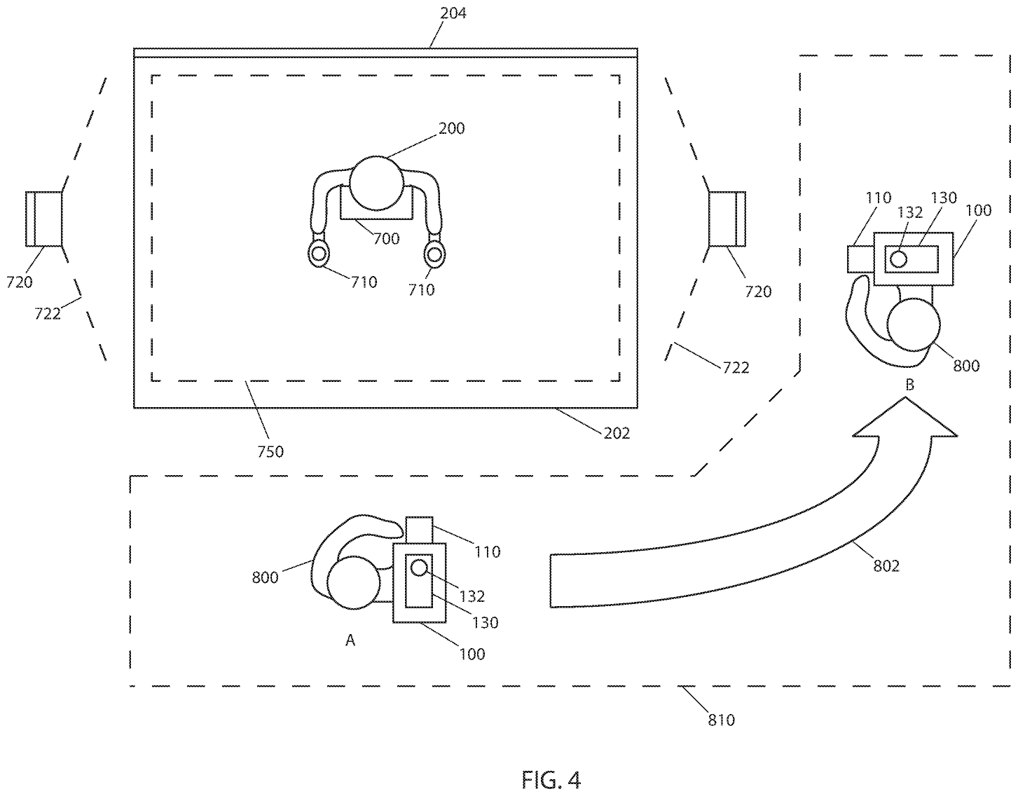

An embodiment of the present disclosure is illustrated in FIG. 4 where as before, player 200 wearing a HMD 700 is viewed from above. Player 200 is standing on a blue or green ground plane 202 and in front of a blue or green background 204. Player 200 is restricted to a player tracking area 750. Player tracking area 750 is determined by the positioning and maximum range of base stations 720, but has a typical maximum size of 15 feet×15 feet. Base stations 720 are located to either side of player tracking area 750. Base stations 720 each have a field of view 722 that determines the shape and range of player tracking area 750.

In addition there is a spectator camera 100 with lens 110 and a wide area tracking sensor 130. This wide area tracking sensor 130 is still fixed rigidly to the spectator camera 100, but uses a different type of tracking system. The wide area tracking sensor 130 can be the Halide Tracker made by Lightcraft Technology of Santa Monica, Calif. Tracking sensor 130 has a camera 132 that faces in an adjustable direction. In a preferred embodiment, camera 132 faces overhead to detect tracking targets 170. This enables tracking sensor 130 to work in a much larger spectator tracking volume 810. Spectator camera 100 is carried by camera operator 800.

Since camera operator 800 is no longer in player tracking volume 750, there are no occlusion areas where player 200's HMD or hand controller tracking is compromised. In addition, camera operator 800 can move in a very large range of motion while staying in spectator tracking volume 810 to cover even large moves by player 200. For example, camera operator 800 can move from position A to position B along path 802 without encountering any occlusion areas and compromising the game experience of player 200.

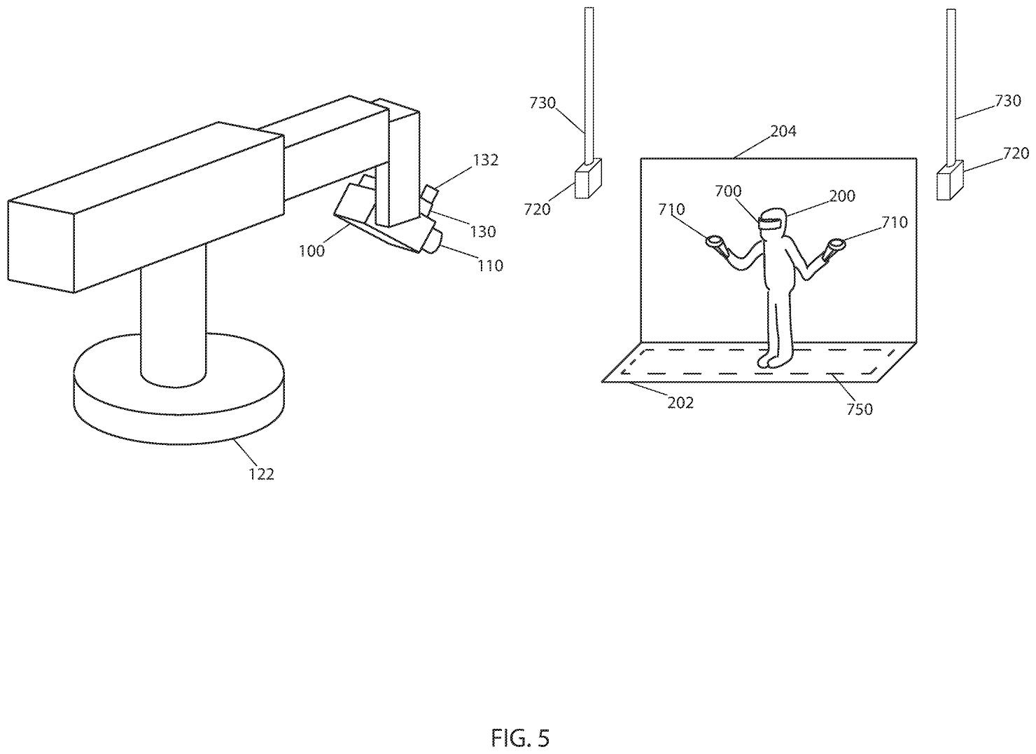

An embodiment of the present disclosure is illustrated in FIG. 5 where player 200 wearing a HMD 700 is viewed in perspective. Player 200 is standing on a blue or green ground plane 202 and in front of a blue or green background 204. Player 200 is restricted to a player tracking area 750, which is determined by the positioning and maximum range of base stations 720, but has a typical maximum size of 15 feet×15 feet. Base stations 720 are located to either side of player tracking area 750, in this case supported from the ceiling by supports 730.

In addition there is a spectator camera 100 with lens 110 and a tracking sensor 130. This tracking sensor 130 is still fixed rigidly to the spectator camera 100. Tracking sensor 130 has a camera 132 that faces in an adjustable direction. In a preferred embodiment, camera 132 faces overhead to detect tracking targets 170. Spectator camera 100 is mounted on telescopic camera crane 122. This type of telescopic crane is common in the entertainment production world, and is used to create dramatic shots that move the camera side to side or up and down in distances up to fifty feet, long past the fifteen foot tracking range of most commercial VR systems. This telescopic crane can be the Technocrane made by Technocrane s.r.o. of the Czech Republic. This type of dramatic shot is used to show the player 200 and a wide area around the player, and is well out of the range of the player tracking volume 750. By using the wide angle tracking sensor 130 to track the motion of scene camera 100, it enables the audience to see player 200 immersed in the same virtual environment that player 200 is experiencing, but from a more dramatic vantage point.

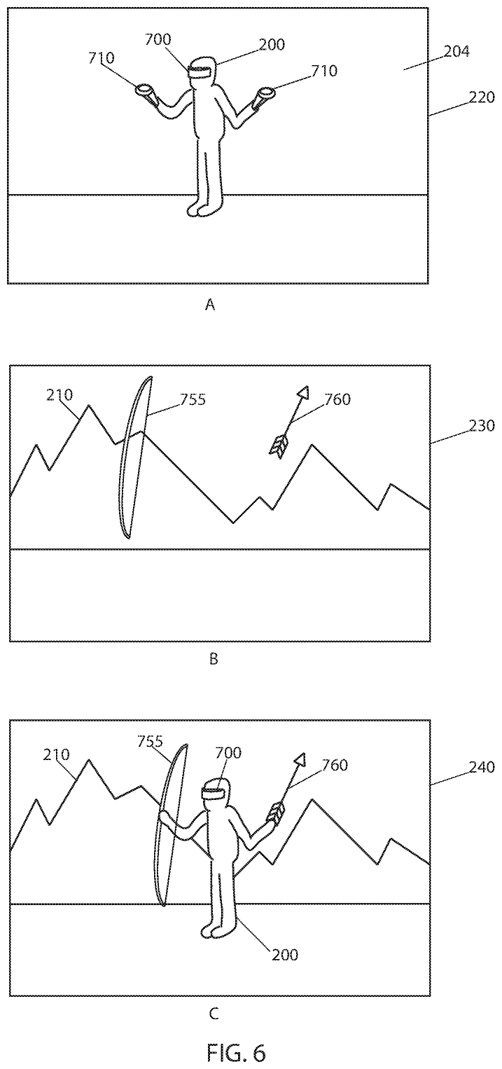

The overall goal of the system is illustrated in FIG. 6. In section A, player 200 is shown wearing HMD 700 and holding hand controllers 710 in front of blue or green background 204. This comprises live action frame 220. The function of tracking sensor 130 is to generate position, orientation, and lens data 392 that can be used to render a virtual background 230 shown in section B containing virtual scene imagery 210 to match with the live action foreground 220. In this case, virtual background 230 also includes virtual elements 755 and 760 that are tracked to the motion of hand controllers 710.

The completed composite is shown in section C, where image 240 with player 200 and virtual imagery 210 are shown, along with virtual elements 755 and 760. It is desirable to accurately composite virtual elements 755 and 760 either in front of or behind player 200. This can be achieved by measuring the XYZ position of HMD 700 worn by player 200, and comparing the depth of the virtual image 230 to the XYZ position of HMD 700, which is also the position of player 200. If the depth of a portion of virtual image 230 is in front of HMD 700, that portion of the virtual image is composited in front of the live action image, and if the depth of the virtual image 230 is behind that of HMD 700, it is composited behind the live action image. This takes place in compositor 440, described in the next figure. This can also optionally be achieved with a separate depth sensor mounted to spectator camera 100. The XYZ position of HMD 700 can be used for simplicity and reliability.

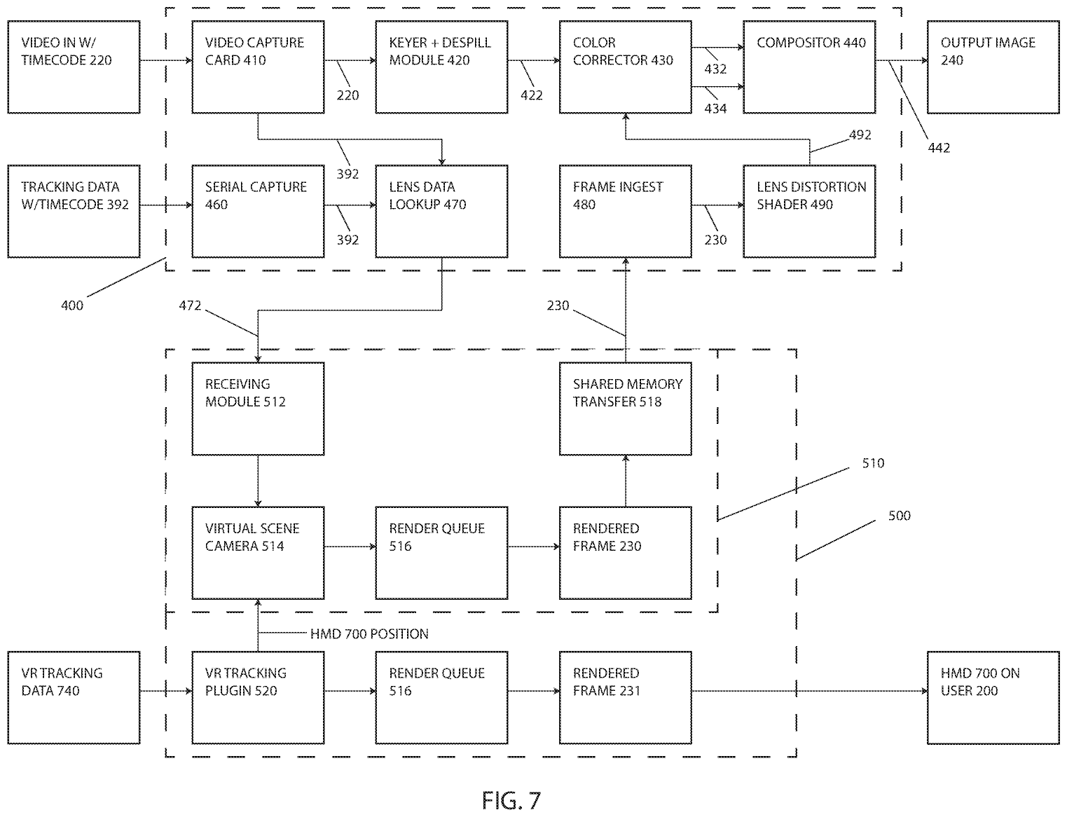

The data flow of this operation is shown in FIG. 7. The 2D compositing and 3D rendering operations in this embodiment all take place on a standard computer 600 with a video I/O card 410 and a GPU. The video I/O card can be a Kona 4 made by AJA Inc. of Grass Valley, Calif. and the GPU can be a GeForce made by nVidia Incorporated of Santa Clara, Calif.

The software running on computer 600 is divided into three major parts: compositing system 400 and 3D rendering engine 500, which has plug-in 510 running as a separate sub-component of 3D engine 500. The compositing system 400 can be the Halide FX system made by Lightcraft Technology of Santa Monica, Calif. and 3D engine 500 can be the Unreal engine made by Epic Games of Cary, N.C.

Inside compositing system 400, the live action video frame 220 is sent from the scene camera 100 over video connection 102 and captured by video capture card 410. Live action frame 220 is then sent to the keyer/despill module 420. This module removes the blue or green background 204, and removes the blue or green fringes from the edges of subject 200. The removal of the blue or green background 204 can be done with a color difference keying operation, which is well understood by practitioners in this field. The despill operation is achieved by clamping the values of green or blue in the live action image 220 to the average of the other colors in that image, so that what was a green fringe resolves to a gray fringe, which is much less visible in the final composite. The despill operation is also well understood to practitioners in the field. The keying process generates a black-and-white matte image called an alpha channel or matte that specifies the transparency of the foreground subject 200, and the combination of the despilled image and the transparency are combined into a transparent despilled image 422 and then sent to color corrector 430.

In cases such as most augmented reality applications, where no blue or green background is present, the keyer and despill can be disabled, and the untouched live action image moves through the data flow as before.

While this is happening, the incoming tracking data packet 392 is captured by serial capture interface 460 and interpreted. This data packet 392 is then sent to the lens data lookup table 470. Lens data lookup 470 uses the incoming data from lens encoders 113 and 114 contained in tracking data packet 392 to determine the present optical parameters of zoom lens 110. This lookup can take the form of reading the optical parameters from a lens calibration table file such as that described in U.S. Pat. No. 8,310,663. A combined data packet 472 containing the current camera pose, lens optical parameters, and a frame number is then sent from compositing system 400 to spectator plugin 510. This data packet 472 can be a UDP packet transferred from one application to another in the same computer 600, using UDP methods well understood by practitioners in the field.

According to one embodiment, 3D engine 500 is running simultaneously on computer 600 with compositing application 400. 3D engine 500 has a VR plugin 520 in it that receives VR tracking data 740, including the position and orientation of HMD 700 and hand controllers 710. This VR plugin 520 is typically provided by the manufacturer of HMD 700. This VR plugin 520 can be the SteamVR plugin made by Valve Software of Bellevue, Wash. When VR plugin 520 receives an updated frame of data, it sends a request to render queue 516 to render a view with the position and orientation of HMD 700, with both right and left eyes included in the render. This rendered frame 231 is then sent to HMD 700 so that player 200 can see the updated scene from the new angle.

3D engine 500 also has a spectator plugin 510 that is running inside it, which connects engine 500 to compositing system 400. Spectator plugin 510 has a receiving module 512 which captures combined data packet 472 when it is transmitted from compositing system 400. This can be received by a UDP socket, a standard programming device known to practitioners in this field. This receiving module 512 can be set to non-blocking form, so that plugin 510 only triggers a render upon receiving data packet 472. Determining whether data packet 472 has been received can be achieved by a simple system call to check if a new UDP packet has come in, using methods well known to practitioners in the art.

If no data packet 472 is received during the evaluation loop of 3D engine 500, spectator plugin 510 performs no operations and immediately returns control to 3D engine 500. This means that 3D engine 500 can continuously render at arbitrary frame rates, while still supplying a set of rendered frames 230 that is precisely synchronized to the exact video frame rate of spectator camera 100. This enables the simultaneous use of rendering engine 500 for both the high frame rate (90+ frames/second) VR/AR application, and the slow-but-precise synchronized frame rate required to seamlessly match with spectator camera 100. This non-blocking nature enables the rest of the engine to run at arbitrary frame rates, instead of attempting to synchronize the overall operation of the engine.

Receiving module 512 decodes the camera pose, lens optical parameters and frame number from data packet 472. Receiving module 512 then sets a virtual scene camera 514 with the incoming live action camera pose, lens optical parameters, and frame number. Virtual scene camera 514 is then entered into render queue 516. In a preferred embodiment, virtual scene camera 514 can use the SceneCapture2D software object in the Unreal Engine. 3D engine 500 then receives the data from render queue 516 and renders the virtual frame 230. In a preferred embodiment, render queue 516 can be the normal render queue provided by the Unreal 3D engine. This virtual frame 230 can have color, transparency, and depth information, as well as other 3D engine information that is useful to compositing system 400. Virtual frame 230 can contain scene color, scene depth, and the 3D location of HMD 700.

After virtual frame 230 is rendered on the GPU, it is transferred to shared memory via shared memory transfer 518. This transfer can be achieved in a variety of ways, including a simple readback as well as cross-process direct GPU transfer. And this can be achieved by simple readback from the GPU to the CPU, a method well understood by practitioners in the art.

When shared memory transfer 518 completes its transfer, it sends a signal to a frame ingest 480 that is located in the 2D compositing system 400. Frame ingest 480 then uploads the numbered virtual frame 230 into computer 600's GPU, and uses the frame number to match it with the corresponding original live action image 220. In a preferred embodiment, the upload process from the CPU to the GPU can be performed by a standard texture upload, a method well understood to practitioners in the art. After the matching process, frame ingest 480 then transfers virtual frame 230 to the lens distortion shader 490. Since physical lenses have degrees of optical distortion, virtually generated images have distortion added to them in order to properly match the physical lens distortion. The lens optical parameters and the lens distortion calculations can be identical to those used in the OpenCV machine vision library, well known to practitioners in machine vision. In a preferred embodiment, the process of adding distortion to the image can be achieved by a real time pixel shader that reads image information from the undistorted image 230 and writes to the distorted image 492 using the radial lens distortion calculation

X_{undistorted}=X_{distorted}(1+k1*radius²)

Y_{undistorted}=Y_{distorted}(1+k1*radius²)

where k1 is the standard OpenCV lens calibration distortion coefficient, and radius is the distance from the center of the image on the sensor of scene camera 100.

Since the barrel distortion commonly found in a wide angle lens causes parts of the scene that would normally not be seen by a lens with zero distortion, this requires that the incoming undistorted image be rendered significantly oversize, frequently as much as 25% oversize from the target final image. This unusual oversize image requirement makes the direct software connection between compositing system 400 and 3D engine 500 critical, as the unusual size of the required image does not match any of the existing SMPTE video standards used by HDSDI type hardware interfaces.

The lens distortion shader 490 sends distorted virtual image 492 into color corrector 430 where it joins despilled image 422. Color corrector 432 adjusts the color levels of the distorted virtual image 492 and the despilled image 422 using a set of color adjustment algorithms driven by the user to match the overall look of the image. The color corrector 430 can use the standard ‘lift, gamma, gain’ controls standardized by the American Society of Cinematographers in their Color Decision List calculations.

After the user has specified the color adjustments with color corrector 430, the color corrected live action image 432 and color corrected virtual image 434 are sent to a compositor 440. Compositor 440 performs the merge between the live action image 432 and the virtual image 434 using the transparency information, or matte, generated by keyer 420 and stored in the despilled image 422. In areas of high transparency (such as where the blue or green colored background 204 were seen), the virtual background will be shown, and in areas of low transparency (such as subject 200), the subject will be shown. This operation is well known to practitioners in the field of compositing.

In addition, it is desirable to accurately composite virtual elements 755 and 760 either in front of or behind player 200. This can be achieved by using the XYZ position of HMD 700 worn by player 200 that was transferred in virtual image 230, and comparing the depth of the virtual image 230 to the XYZ position of HMD 700, which is also the position of player 200. If the depth of a portion of virtual image 230 is in front of HMD 700, that portion of the virtual image is composited in front of the live action image, and if the depth of a portion of the virtual image 230 is behind that of HMD 700, it is composited behind the live action image. This can also optionally be achieved with a separate depth sensor mounted to spectator camera 100. The XYZ position of HMD 700 can be used for simplicity and reliability. This together creates output image 240, which is transferred out of compositing system 400 and computer 600 through output link 442. The output link 442 can be the output side of the video capture card 410.

In the case of adding an augmented reality character to the live action image without a blue or green screen, the transparency information of the virtual background, which is typically contained in the rendered image as an alpha or transparency channel, is used along with the depth information to determine which parts of the virtual image should be rendered onto the live action image.

The separation of the compositing system 400 and the 3D render engine 500 has a number of benefits. There are a large number of competing real time 3D engines on the market, and different users will want to use different 3D engines. The use of a simple plug-in that connects the 3D render engine 500 to compositing system 400 on the same computer 600 enables the 3D engine 500 to be rapidly updated, with only a small amount of code in plugin 510 required to update along with the changes in the render engine.

In addition, the separation of the code of spectator plugin 510 from render engine 500 means that multiple game developers can use the system without requiring a deep code integration. All they need to do is add the pre-compiled spectator plugin 510 to their game that they are building in 3D engine 500, and run their game on computer 600. In this way, no IP needs to be shared to enable this process, which is a requirement for many commercial productions.

In addition, the use of a separate spectator plugin 510 that receives data packet 472 on its own thread, and places a render request in render queue 516 means that 3D engine 500 is not required to render at a fixed frame rate to match video, which is important as most major 3D engines are not designed to synchronize with video frame rates. Instead, the engine itself can run considerably faster than video frame rate speeds, while the spectator plugin only responds at exactly the data rate requested of it by compositing system 400. In this way, a wide range of render engines that would not typically work with standard video can be made to render frames that match correctly in time with video. In addition, since the spectator plugin 510 is non-blocking, rendering engine 500 is free to render at the very high frame rates (90+ frames/second) required for a clear update to HMD 700. This way, the same engine can handle two very different frame rates simultaneously, while keeping the scene perfectly synchronized between the viewpoints of user 700 and spectator camera 100.

Similarly, the simultaneous use of compositing system 400 and 3D engine 500 on the same computer 600 means that the data interface between the two can be defined completely in software, without requiring an external hardware interface. The traditional method to combine 3D with 2D imagery required two separate systems connected with synchronized HDSDI hardware links. This meant a fixed bandwidth link that was very difficult to modify for custom imagery formats, such as depth images and HMD XYZ positions. In addition, the HDSDI hardware interface has a fixed format that was the same resolution as the image (for example, 1920 pixels across by 1080 pixels vertically.) Since images that are going to be distorted to match wide angle lens values have to be rendered larger than their final size, the use of a fixed resolution hardware interface forces the 3D engine to render with distortion, and very few 3D engines can render accurate lens distortion. The use of a software defined data path solves this problem, and places the work of distorting incoming images onto compositing system 200, where the same distortion math can be applied to all incoming images.

In addition, as network speeds increase, it becomes possible to extend this method to two separate processing systems. In this case, the 3D engine can reside on a phone or mobile device, such as when a player is playing a game on their phone that uses augmented reality. The data packet 472 is transmitted across the network, and the rendered virtual frame 230 can be transferred back. In this way, it is possible to extend the spectator VR method to work with mobile systems, while keeping the compositing on a separate PC for production efficiency.

The resulting composited image 240 can be used in a variety of manners. For example, the camera operator 800 can view composited image 240 on a camera monitor or eyepiece to best frame the action of player 200. An audience can simultaneously see the same image 240 projected on a large display or transmitted online.

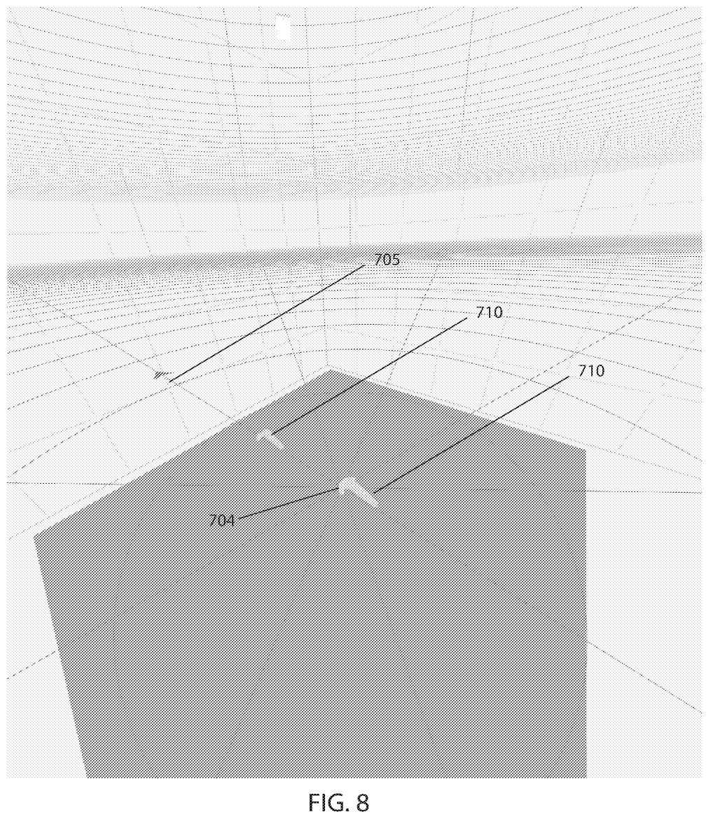

Another embodiment is shown in FIG. 8, and it is a screen capture from the default display of the HTC Vive. The virtual coordinate system origin 704 is shown where all of the lines on the floor converge. The virtual X axis 705 is clearly marked with an arrow. In this case, one hand controller 710 has been placed exactly at the origin 704, and one hand controller 710 has been placed on the virtual X axis 705. The virtual representations of the hand controllers 710 are very closely correlated with the physical hand controllers 710, making this an accurate method for locating the virtual origin 704 and virtual X axis 705 in the physical world. After placing the hand controllers while wearing the HMD 700, it is straightforward to place origin marks and X axis marks 701 and 703 on floor plane 202. This is shown in the next figure.

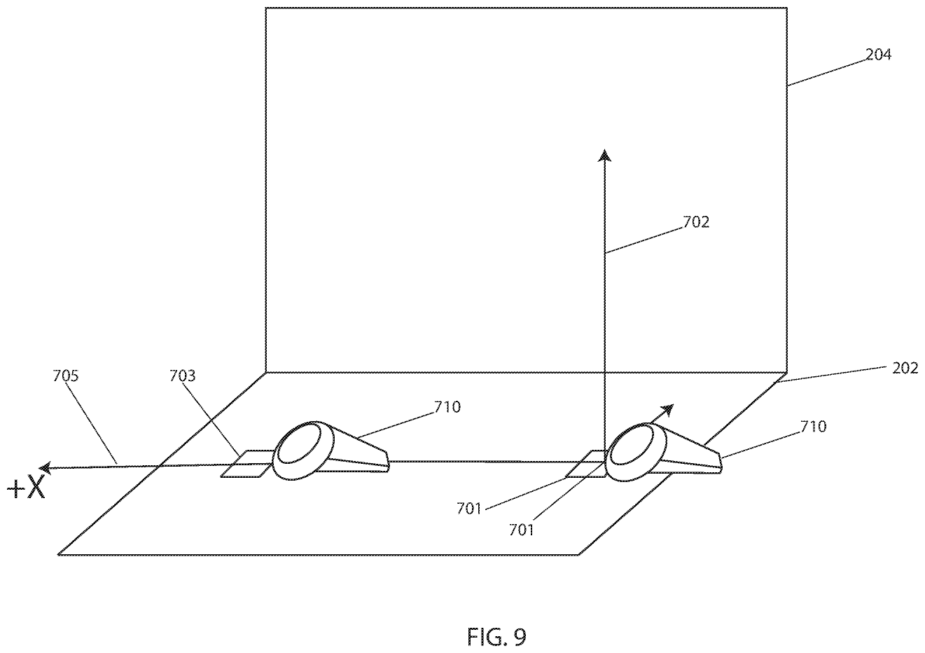

Another embodiment is shown in FIG. 9 where a VR coordinate system 702 is shown with the coordinate system origin 704 located on floor plane 202 and in front of background 204. Coordinate system 702 is automatically set by VR systems such as the Oculus and the Vive. For correct matching of the wide area tracking sensor 130 with the virtual background 230, the origin and X axis of VR coordinate system 702 must be known. This is achieved by placing a physical origin mark 701 at the tip of the hand controller 710 that is placed at the virtual origin 704. A physical X axis mark 703 is placed at the tip of hand controller 710 that is located on the virtual X axis 705.

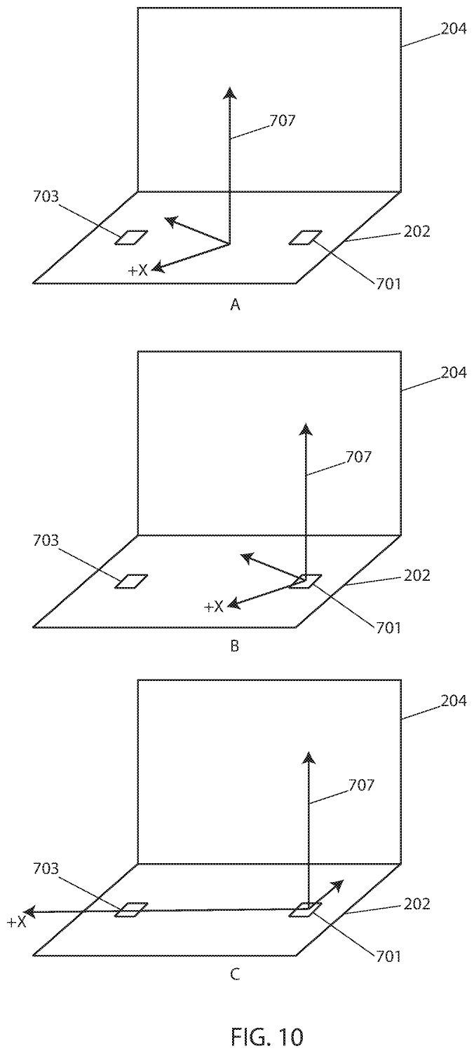

The steps to achieve alignment of the wide area tracking sensor 130 to the VR coordinate system 702 are shown in FIG. 10. All three views A, B, and C are of the composited output image 240, but instead of a virtual scene 210 being added, only the virtual scene's coordinate system 707 is displayed. In section A, origin marker 701 and X axis marker 703 are placed on floor plane 202 in front of background 204 as per the steps in previous figures. Wide area coordinate system 707 is shown overlaid on the live action image.

This overlay can be accomplished in compositing system 400. Compositing system 400 can be the Halide FX system made by Lightcraft Technology of Santa Monica, Calif. The origin of wide area coordinate system 707 is not yet aligned with the origin mark 701, but by adjusting the origin offsets in tracking sensor 130, wide area coordinate system 707 can be shifted around on ground plane 202. Most wide area tracking sensors provide a method to relocate their origin to best fit the user's needs. The wide area tracking sensor 130 can be the Halide Tracker made by Lightcraft Technology of Santa Monica, Calif.

In section B, wide area coordinate system 707 has been shifted until its origin aligns with origin mark 701. However, the X axis of wide area coordinate system 707 is not yet aligned. By adjusting the yaw offset in tracking sensor 130, the X axis will rotate around the origin. In section C, the X axis of wide area coordinate system 707 has been rotated to align with X axis marker 703, and the wide area and VR coordinate systems are now aligned, so that the virtual background 230 and virtual props 755 and 760 will properly align with the view of player 200 in the finished composite image 240.

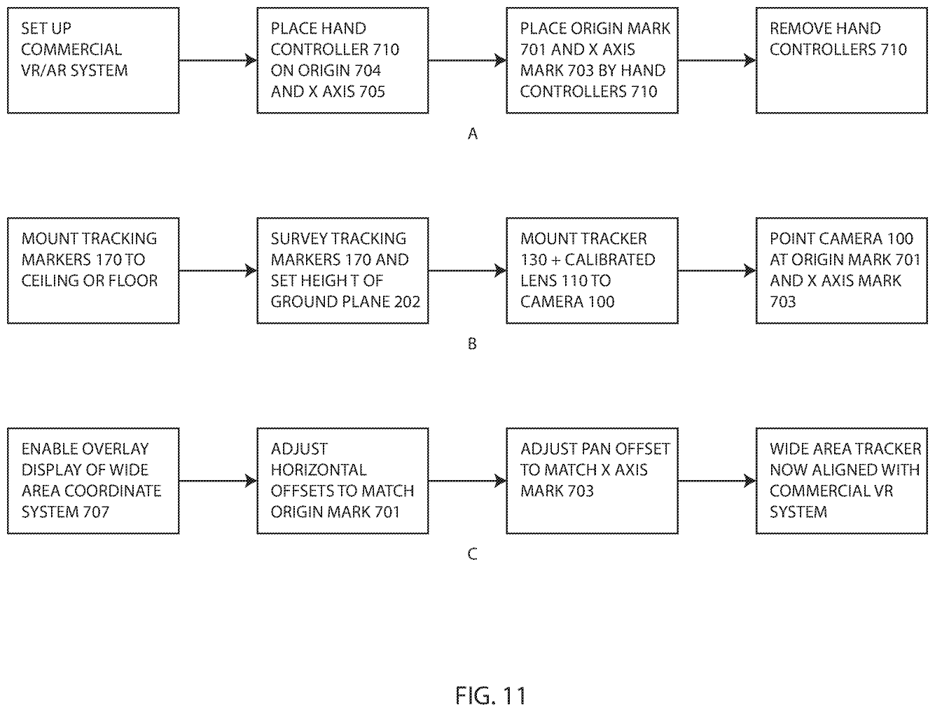

A flow chart for user alignment of the coordinate systems is shown in FIG. 11. Section A lists the process of determining the physical location of the virtual origin 704. First, the commercial VR system is set up according to the manufacturer's instructions. This can be a HTC Vive, an Oculus, or other VR system. In a preferred embodiment the commercial VR system can be a HTC Vive. The hand controllers 710 are placed on virtual origin 704 and virtual X axis 705 while the user wears HMD 700 to see the virtual locations of these two points. Next, the origin mark 701 and X axis mark 703 are placed on ground plane 202 by the respective hand controllers 710. Finally, the hand controllers 710 are removed, leaving origin mark 701 and X axis mark 703 on the floor plane 202 to represent the virtual origin 704 and virtual X axis 705.

Section B lists the process of setting up the wide area tracking sensor 130 and spectator camera 100. Tracking markers 170 are placed to be visible to tracking sensor 130. In a preferred embodiment, they are placed on the ceiling of the space. Tracking sensor 130 is used to survey the locations of the mounted tracking markers 170 with the bundled solve process described previously. This survey process can be accomplished by the Halide Tracker wide area tracker, made by Lightcraft Technology of Santa Monica, Calif. Once the tracking markers 170 are surveyed, the position of ground plane 202 is established with respect to the surveyed tracking markers 170. This can be accomplished by setting tracking sensor 130 on the floor plane 202 so that it can see sufficient numbers of tracking markers 170 to calculate its pose, and confirming this ground position on the user interface of tracking sensor 130.

Once the wide area tracking sensor 130 is correctly referenced to the floor plane 202, it is mounted to spectator camera 100 and aligned to spectator camera 100 and lens 110. This process is accomplished by aiming the lens of both the spectator camera 100 and tracking sensor 130 up at overhead targets 170, and solving the pose for each using the Perspective 3 Point Problem algorithm described earlier. When the pose for both lenses is known, the offset between spectator camera 100 and tracking sensor 130 is simply the 3D difference between the two solved poses. This alignment calculation can be performed by the Halide FX software made by Lightcraft Technology of Santa Monica, Calif. After spectator camera 100 is correctly aligned to tracking sensor 130, spectator camera 100 is pointed so that physical origin mark 701 and X axis mark 703 are visible to lens 110.

Section C describes the process of matching the wide area coordinate system 707 to VR coordinate system 702. An origin overlay is enabled in compositing system 400 to show the location of wide area coordinate system 707 on top of the live action image 220 from spectator camera 100. This can be done with the Halide FX system made by Lightcraft Technology of Santa Monica, Calif. Next, the horizontal origin offsets in wide area tracker 130 are adjusted, to move the wide area coordinate system 707 so that its origin aligns with origin mark 701. Finally, the pan or yaw offset in wide area tracker 130 is adjusted so that the X axis of wide area coordinate system 707 aligns with the X axis marker 703. Once this is complete, the wide area coordinate system 707 is aligned with the VR coordinate system 702.

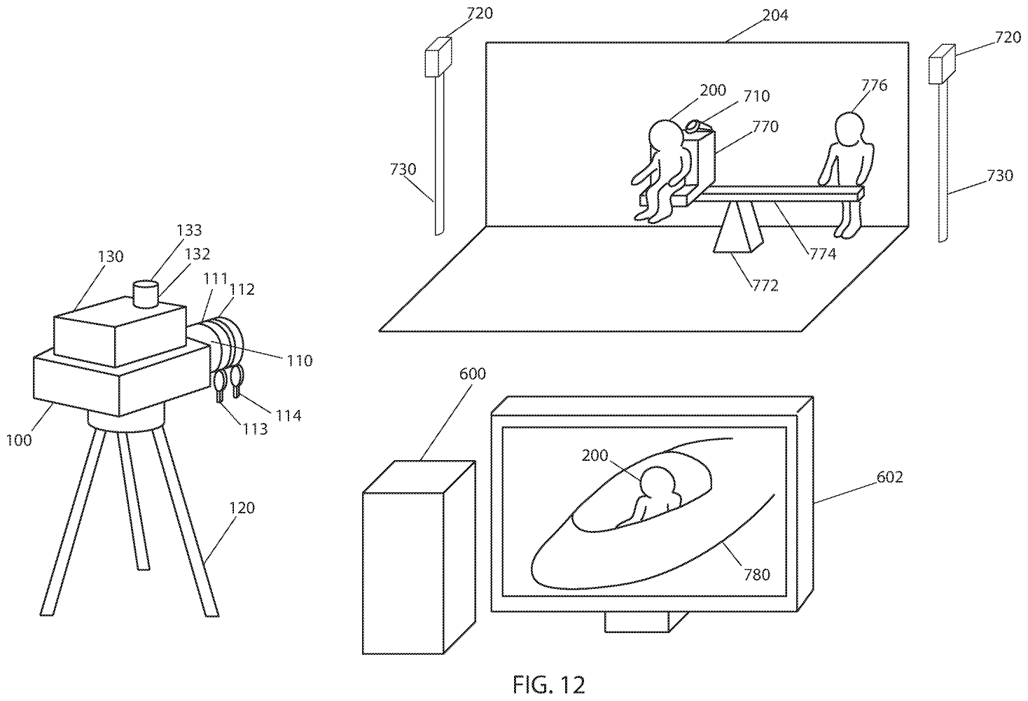

Another embodiment is shown in FIG. 12. A spectator camera 100 has a lens 110 with adjustable zoom and focus rings 111 and 112. A wide area tracking sensor 130 with tracking camera 132 and wide angle lens 133 is mounted rigidly to camera 100. Tracking sensor 130 reads the position of zoom and focus rings 111 and 112 through lens encoders 113 and 114. Spectator camera 100 is mounted on camera support 120, which as before may be a tripod, dolly, crane, or any other means of holding and moving a spectator camera.

Subject 200 sits on support 770 that is held up by lever 774 and supported by pivot 772. Stage hand 776 moves lever 774 to move the support 770 and thus the subject 200. Support 770 may be any type of support or object that is desired to move on set and be tracked, including motion bases, horses, car platforms, etc. Support 770 can be a simple support that can be easily manipulated by a stage hand. Hand controller 710 is mounted rigidly to support 770.

Subject 200 and support 770 are in front of background 204, which can be a blue or green color to enable separation of subject 200 from the background. In addition, base stations 720 mounted on supports 730 are positioned on either side of subject 200. In this case, subject 200 does not need to be wearing HMD 700, as the XYZ position of subject 200 is now derived from hand controller 710 instead of HMD 700. The location of both HMD 700 and hand controllers 710 are available in 3D engine 500 to be transferred to spectator plugin 510, so that the correct 3D foreground elements and background elements can be rendered in front of and behind subject 200 as in previous descriptions.

As before, subject 200 is photographed by spectator camera 100 and composited into a 3D scene shown on monitor 602. In this case, subject 200 is composited into a virtual airplane cockpit 780, so that a flying shot can be simulated on a sound stage. This same technique can also be used to achieve shots where subject 200 is supposed to be driving, riding an animal, or any other shot where the subject 200 is on a surface that will be moved around and needs to have a CG set object track along with it.

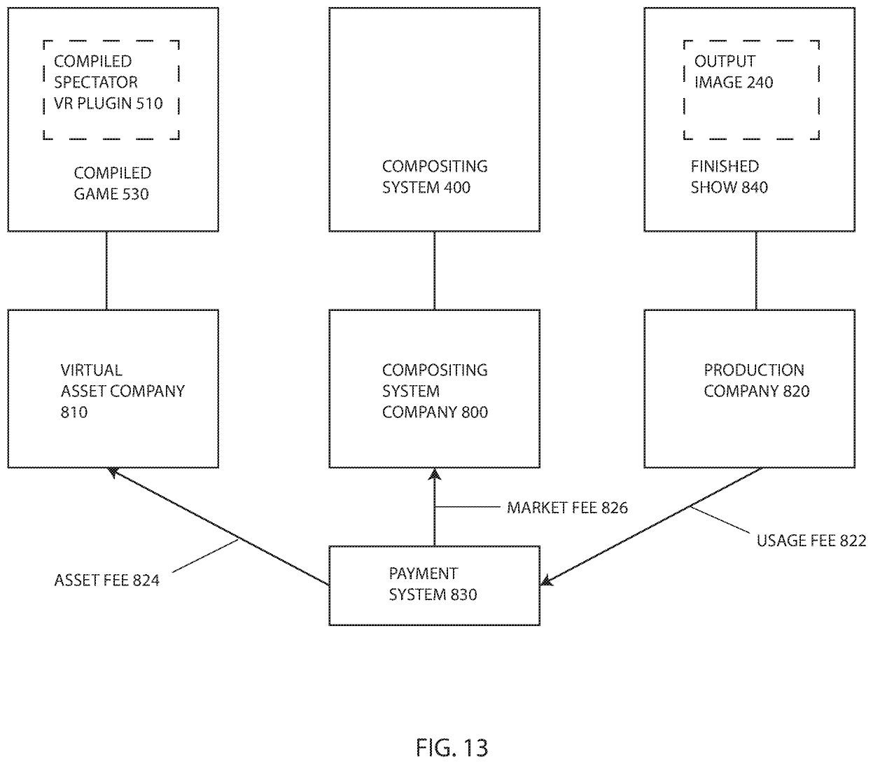

An additional embodiment of the present invention is shown in FIG. 13. This diagram shows three business entities, including virtual asset company 810, compositing system company 800 and production company 820. In addition, it shows the intellectual property owned by each of these business entities. Virtual asset company 810 owns compiled game 530, compositing system company 800 owns compositing system 400 and compiled spectator VR plugin 510 (which is licensed to VR asset company 810), and production company 820 owns finished show 840. In addition, it shows payment system 830.

Since the virtual asset company 810 can add the pre-compiled spectator VR plugin 510 to their game, and then compile or “bake” the game into a final compiled game 530, still containing the pre-compiled spectator VR plugin 510, this enables the virtual asset company 810 to rent their intellectual property in the form of a virtual set inside compiled game 530 to production company 820 without the danger of production company 820 copying or using compiled game 530 without payment. Compiled game 530 is simply the combination of 3D engine 500 with the specific in-game content created by the virtual asset company 810, compiled into a final executable form.

Since the generation of composited frames 240 is controlled by the compositing system 400, a payment requirement can be placed into compositing system 400 and pre-compiled spectator plugin 510 that protects compiled game 530 and enforces payment by production company 820 in order to generate finished composited frames 240 that will be incorporated into finished show 840. This is very useful and enables the business separation of virtual set creators and virtual set users, and the creation of a protected marketplace for virtual assets. Payment system 830 can be a standard online payment system well understood to practitioners in the art. Production company pays usage fee 822 for the use of compiled game 530 to payment system 830, which then separates usage fee 822 into the asset fee 824 which is paid to virtual asset company 810, and market fee 826 which is paid to compositing system company 800. Market fee 826 is typically a small fraction of the usage fee 822, paid for enabling the marketplace to exist while protecting intellectual property.

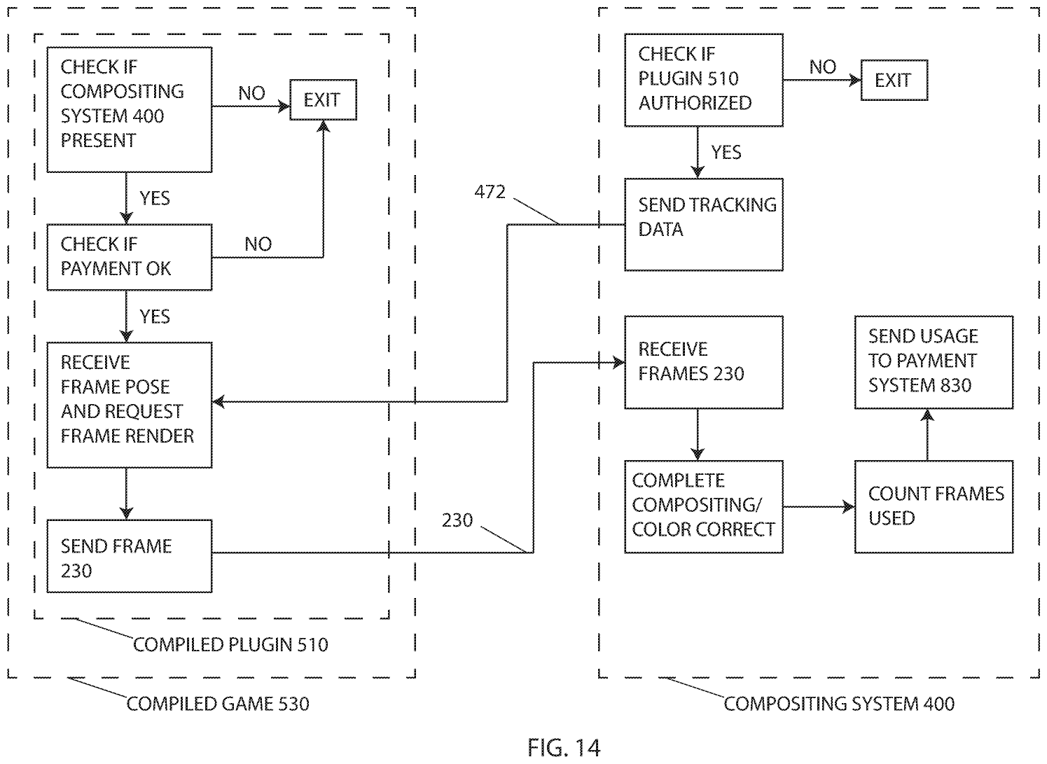

An additional embodiment of the present disclosure is shown in FIG. 14. This block diagram shows the technical mechanism by which the compositing system 400 and compiled plugin 510 control the use of compiled game 530. Compiled plug-in 510 is contained within compiled game 530. Upon execution, compiled plug-in 510 can check to see if compositing system 400 is present on the same system. This can be achieved through a variety of methods known to the practitioner to verify if another specific executable program is running on the same system. If the compositing system 400 is not detected, the plugin 510 may exit, and stop the execution of compiled game 530 immediately. Compiled plugin 510 can then check to see if payment has been sent and approved by payment system 830. This can take place via a variety of methods known to the practitioner; for example, it can be achieved by a simple online query and response to a central payment server. If payment system 830 approves, plugin 510 can then receive tracking data packets 472 from compositing system 400, as previously described, and render virtual frame 230. Plugin 510 then sends rendered virtual frame 230 to compositing system 400 using data transfer methods previously described.

Compositing system 400 can begin execution by checking whether plugin 510 is authorized by payment system 830. This can occur using a variety of methods. This can take the form of a simple online query and response to payment system 830, as previously described. If the plugin 510 is not authorized, compositing system 400 can cease execution and exit. If authorized, compositing system 400 can begin sending tracking data packets 472 to compiled game 530 as previously described. When compositing system 400 receives rendered virtual frames 230, it can then complete the compositing and color correction as previously described. Compositing system 400 can also count the total number of output images 240 that have been created in a session, and optionally send this usage information to payment system 830. In this way, the combination of compositing system 400 and pre-compiled plugin 510 can work together to provide a secure method for compiled game 530 to be used by production company 820 while protecting the intellectual property of virtual asset company 810.

Thus, systems of the present disclosure have many unique advantages such as those discussed immediately below. Since the spectator camera is using a separate wide area tracking system, the camera operator can stay outside of the player's tracking volume and avoid interfering with the tracking performance and the player's VR experience. In addition, if the spectator camera is outside of the player's tracking volume, there is no danger of the camera operator and the player colliding when the player is moving quickly. Furthermore, the separation of the tracking volumes makes possible a range of artistic shots that are desirable from the point of view of the audience observing the player's actions. In addition, the use of a separate wide area tracking system makes it possible to also track camera lens changes, such as zoom and focus, that are highly desirable for camera operators, but are not supported by the default VR systems.

Since the rendering engine integration is achieved with a separate plug-in, the technology can be integrated with any VR or AR application that is created with that engine, without requiring sharing source code between the two parties. In addition, since the plugin is a non-blocking type of plugin, which only sends a request to the render engine when it receives a tracking data packet, the same render engine can supply images that are synchronized to both the spectator camera and the VR headset, at very different frame rates.

The use of a separate compositing application to process the live action video and perform the final compositing eliminates the need to directly integrate spectator VR code directly into the game. Instead of trying to build a real time keyer directly into the game engine, it is possible to drop a pre-compiled plugin into an existing game and instantly transfer the rendered frames with depth information back to the separate 2D compositing application running simultaneously on the same PC. This also enables a straightforward virtual asset rental model, where the virtual game creator adds the spectator VR plugin to their game, and compiles a protected executable version of the game that can then only be read by the compositing system. Rendering a wide area coordinate system overlay in the 2D compositing application makes it straightforward to align the coordinate systems of the wide area tracking system and the player's VR/AR tracking system.

Furthermore, placing the lens distortion into a separate 2D compositing application means that a variety of real time rendering engines can be used that do not natively support rendering accurate lens distortion, much less accurate zoom lens tracking.

By transferring the color, transparency, the depth data of the rendered frame, along with the current XYZ location of the user's head mounted display, it is possible to correctly render the virtual elements in front of or behind the live action image of the player. It is also possible to render a virtual character over a live action scene without using a green or blue background, simply by using the rendered transparency information sent with the rendered frame to the compositing system.

It is also possible to have a separate device render the virtual frames and send them back over a sufficiently high speed network, making it possible to use the method with AR/VR applications on mobile phones and devices with high speed wireless network connections.

This also has applications outside the VR environment; anything where a user is manipulating a virtual object that needs to be seen by a third party, or when an actor is on a motion base or car platform that needs to have VFX CG extensions applied to it to simulate a driving, flying or riding shot.

Alternative embodiments include using a markerless or motion capture based wide area tracking system instead of the marker based system. The overall setup would be similar, but for some situations avoiding visible markers is desirable.

An additional alternative embodiment involves running the separate 2D compositing system on a separate computer. With a sufficiently fast network, the transfer of image frames over the network would make the same technique work for physically separated 3D rendering and 2D compositing systems. In this way, a VR/AR system that is not tethered to a PC but instead has its own on-board rendering can still be composited live. In this case, the UDP packets would be broadcast to the VR system, and the plugin would send back the rendered images over the network instead of a shared memory connection. With a modern high-speed wireless network, this can even work for an augmented reality game being played on a portable phone.

An additional alternative embodiment would be to use a depth sensor mounted on the spectator camera. This would send a stream of depth images to the 2D compositor, which would use this instead of the HMD's XYZ position to determine which parts of the 3D scene to render in front of or behind the live action player.

### Summaries of Selected Aspects of the Disclosure

1. A system to enable a moving spectator camera to view the world that a virtual reality or augmented reality user is engaged with, which can include: a standard VR system (like the Oculus, or Vive) and a separate wide area tracking system, using non-conflicting tracking technology, matched with the coordinate system of the Vive; a separate spectator camera to view the VR or AR player; and a separate compositing system to integrate the VR or AR player with a perspective-matched view of the virtual environment that they are experiencing, but from the spectator camera's point of view.

This system can track and show positions outside of or above standard VR tracking volume, by using a separate wide-area tracking technology that does not interfere with the standard VR tracking system technology. In contrast, prior art methods of achieving mixed reality have generally used the same tracking technology as the VR system, which limits camera motion to the tracking envelope the VR system is capable of, and forces the camera operator to be dangerously close to the player.

2. A system that avoids causing tracking occlusion with the main VR system, by allowing the spectator camera operator to be outside of the tracking range of the main VR system.

This system increases safety by keeping the spectator camera operator out of the main VR tracking volume, so that the VR player cannot accidentally hit the spectator camera operator by swinging their arms.

3. A system that does not require source code integration with the game it is observing, and achieves integration by transferring rendered color and depth information from an in-game plugin to an external compositing system.

This is important as the use of the spectator VR plugin 510 (see FIG. 7) does the work of implementing a spectator VR and payment mechanism into the game asset, and the pre-compiled nature of the plugin prevents the game creator from removing the payment mechanism. If the game creator wants to be paid, they have to use the plugin, but they do not need to understand the technical details of either the spectator VR method or the payment methods. There has not been a good way in the prior art to protect the IP of a virtual asset like a game while still enabling it to be used for a production, as the raw 3D files are not copy protected. The game engine executable, however, is protected, as the output images can only be generated by running the executable.

4. A system that uses a simple to integrate pre-compiled game engine plugin, so that no intellectual property exchange is required to enable a new game to be compatible with the system.

This system compiles the spectator VR plugin 510 before distributing it to the game creator, which means that this spectator VR technology and this payment protection technology cannot be modified by the game creator to go around our payment enforcement system. Additionally, the system can allow sets to be rented by users while protecting the original set creator, by using games compiled with a custom plugin, with the rental handled by the compositing system.

5. A system that simultaneously handles both high frame rate AR and VR rendering, and low frame rate synchronized spectator camera rendering in the same 3D rendering engine without conflicting.

This system uses the non-blocking mechanism described in FIG. 7 for the spectator VR plugin 510. Since the plugin 510 does not do anything until it receives a data packet 472, and has no inherent internal delay, it does not conflict with the high speed VR rendering requirements simultaneously being generated by VR tracking plugin 520. This enables a VR game that was never designed for spectator VR use to enable spectator VR capabilities by adding in a spectator VR plugin 510, without affecting the primary VR performance of the game. Most games with spectator VR or mixed reality capability require this to be designed into the game from the beginning.

6. A system that can work with a mobile or smart phone based augmented reality application, to show what the player is seeing through their phone from a separate spectator point of view.

This system uses a high-speed network connection between the phone and the compositing system 400, as they are no longer on the same computer. However, it enables the spectator VR system to work with the current crop of AR games, such as Pokemon Go, so that the user can play the game, and the spectator camera can show the user immersed in the world of the game. This system uniquely shows a user of a phone based AR or VR game as being inside the world of the game. The process would be mostly the same, with installing spectator VR plugin 510 into the phone game before it is compiled (the phone games use the same 3D engines as other VR and AR users, for the most part.)

7. A system that can enable inexpensive real time tracking of a motion base, or real time tracking of other props in the scene.

This is represented in FIG. 12. The hand controllers 710 from a normal VR system are accurate, but they have a very limited range of motion that is very limiting for cinematic camera tracking. However, their range of motion is adequate for several on-set tracking needs, such as a support 770 for a virtual cockpit. Typical motion bases are computer controlled and very expensive, but adding a hand controller 710 onto a support 770 enables the use of a very simple manually operated support 770 to be moved around by a stage hand 776, while still being tracked accurately in real time. This uniquely allows the replacement of a multi-million dollar piece of dangerous equipment with a simple manually operated see-saw, while retaining the real-time tracking capabilities of the motion base.

8. A method of renting a virtual asset which includes: adding in a pre-compiled plugin to a virtual scene in a game engine, that will not execute in the absence of a compositing system; compiling the game to generate a finished executable game; loading the game executable onto a computer with a compositing system that can connect to the pre-compiled game plugin; and charging a payment through the compositing system for final rendered frames generated by the compiled game asset.

The pre-compiled game plugin and the compositing system are both pieces of software created by the compositing software company. The game asset is created by a game generation company, and the final rendered frames are then created and owned by a production company. This separation of intellectual property enables the creation of a market where asset creators can rent their virtual assets to production companies, who will then make a finished product using the game asset but will not be able to copy or distribute the asset, or use it without paying. The payment mechanism is enforced by the company building the compositing system and the pre-compiled plugin. This method protects 3D assets from being copied while still enabling them to be loaded and used by a third party.

Although the inventions disclosed herein have been described in terms of a preferred embodiments above, numerous modifications and/or additions to the above-described preferred embodiments would be readily apparent to one skilled in the art. The embodiments can be defined, for example, as methods carried out by any one, any subset of or all of the components as a system of one or more components in a certain structural and/or functional relationship; as methods of making, installing and assembling; as methods of using; methods of commercializing; as methods of making and using the terminals; as kits of the different components; as an entire assembled workable system; and/or as sub-assemblies or sub-methods. The scope further includes apparatus embodiments/claims of method claims and method embodiments/claims of apparatus claims. It is intended that the scope of the present inventions extend to all such modifications and/or additions and that the scope of the present inventions is limited solely by the claims set forth below.

1: A viewing system, comprising:
a VR or AR system;
a wide area tracking system that uses non-conflicting tracking technology matched with a coordinate system of the VR or AR system;
a spectator camera configured to view a VR or AR player of the VR or AR system; and
a compositing system configured to integrate the VR or AR player with a perspective matched view of a virtual environment that the player is experiencing from the point of view of the spectator camera.

2: The viewing system of claim 1 wherein the compositing system includes a real time keying algorithm and the algorithm is a color difference keying algorithm.

3: The viewing system of claim 1 wherein the VR or AR system includes a positional tracking system and a head mounted display.

4: The viewing system of claim 1 wherein the spectator camera includes a real time digital video output.

5: The viewing system of claim 1 wherein the spectator camera is operatively movable with respect to the VR or AR system so as to enable spectators to see the player's actions in the context of the game the player is playing.

6: The viewing system of claim 1 wherein the tracking technology includes a wide area position, orientation and lens measurement system.

7: The viewing system of claim 1 wherein the compositing system is configured to operate by receiving live video from the spectator camera and tracking information from the tracking system, reading lens optical data from a lens calibration, transmitting the tracking data to an external 3D engine, receiving rendered 3D frames from the 3D engine, and compositing the live video with the rendered 3D frames.

8: The viewing system of claim 1 wherein the compositing system prevents tracking occlusion with the VR or AR system by allowing an operator of the spectator camera to be outside of a tracking range of the VR or AR system.

9: The viewing system of claim 8 wherein the compositing system prevents tracking occlusion by using a different tracking technology than that of the VR or AR system.

10: The viewing system of claim 1 wherein the compositing system is configured to keep an operator of the spectator camera out of a main VR or AR tracking volume of the VR or AR system.

11: The viewing system of claim 10 wherein the compositing system keeps the operator out of the volume by using a wide area tracking system that is configured to measure position outside of the range of base station based VR tracking devices.

12: The viewing system of claim 10 wherein the main VR tracking volume is the distance over which the position sensors of a base station type of VR or AR system can accurately localize the user's headset and/or hand controllers.

13: The viewing system of claim 1 wherein the spectator camera has adjustable zoom and focus.

14: A method of renting a virtual asset comprising:
adding in a pre-compiled plugin to a virtual scene in a game engine, that will not execute in the absence of a compositing system;
compiling the game to generate a finished executable game;
loading the game executable onto a computer with a compositing system that can connect to the pre-compiled game plugin; and
charging a payment through the compositing system for final rendered frames generated by the compiled game asset.

15: A method comprising:
transferring rendered color and depth information from an in-game plugin to an external compositing system to achieve integration of live action images of a player from a broadcast or cinema type of video camera with rendered virtual images from a separate 3D engine.

16: The method of claim 15 wherein the in-game plugin is configured to receive incoming tracking data in a non-blocking manner and to avoid compromising performance of the VR or AR user's rendering while sending out rendered virtual frames synchronized with video frame rates.

17: The method of claim 16 wherein the transferring is by a shared memory connection, wherein upon execution each side of the transfer checks for an existing shared memory area, and creates a shared memory area if it does not exist.

18: The method of claim 15 wherein the 3D rendering engine is configured to transfer transparency information to the compositing system.

19: The method of claim 15 further comprising compiling the plugin before distributing it to a creator of a VR or AR game.

20: The method of claim 15 wherein the compiled plugin is configured to receive tracking data and queue a frame to be rendered by the 3D engine, then send it back to the compositing system.

21-61. (canceled)
